(19) United States
(12) Patent Application Publication
(10) Pub. No.: US 2021/0089213 A1
(43) Pub. Date: Mar. 25, 2021

(54) INFORMATION PROCESSING APPARATUS AND CONTROL METHOD OF INFORMATION PROCESSING APPARATUS

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Sohei KUSHIDA, Meguro Tokyo (JP); Tatsuya TOKUE, Yokohama Kanagawa (JP); Haruya IWATA, Kawasaki Kanagawa (JP); Satoshi KAMIYA, Kawasaki Kanagawa (JP); Takayuki MORI, Nagareyama Chiba (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 16/807,791

(22) Filed: Mar. 3, 2020

(30) Foreign Application Priority Data
Sep. 24, 2019 (JP) 2019-173332

(51) Int. Cl. G06F 3/06

(52) U.S. Cl. CPC G06F 3/065; G06F 3/068; G06F 3/0619

(57) ABSTRACT

An information processing apparatus comprises a central processor, a volatile memory, a non-volatile memory, a backup line, and a controller. The volatile memory is configured in such a manner that data is input and output thereto and therefrom via a bus under control of the central processor. The non-volatile memory is configured in such a manner that data is input and output thereto and therefrom via the bus under control of the central processor. The backup line is provided between the volatile memory and the non-volatile memory. The controller is configured to control data transfer performed between the volatile memory and the non-volatile memory via the backup line in a transition period between a normal mode of supplying normal power to the volatile memory and a low power consumption mode of reducing or interrupting normal power to be supplied to the volatile memory.

### CROSS-REFERENCE TO RELATED APPLICATIONS

This application is based upon and claims the benefit of priority from Japanese Patent Application No. 2019-173332, filed on Sep. 24, 2019; the entire contents of which are incorporated herein by reference.

### FIELD

Embodiments of the present invention relate to an information processing apparatus and a control method of an information processing apparatus.

### BACKGROUND

Microcomputer products generally have, in addition to a normal mode, a low power consumption mode that is prepared to bring the products into a low power consumption state. Data in a volatile memory represented by an SRAM (Static Random Access Memory) is lost in the low power consumption mode. Accordingly, a non-volatile memory is used in data backup processing for a volatile memory.

In the data backup processing, a process of transferring data in a volatile memory to a non-volatile memory before transition to the low power consumption mode and retransferring the data from the non-volatile memory to the volatile memory after return to the normal mode is performed. This data transfer between the non-volatile memory and the volatile memory is performed by a CPU (Central Processing Unit) via a bus. However, because the CPU also performs other processes than the data transfer by software processing, there is a risk that the data transfer takes time depending on the processing status of the CPU.

### BRIEF DESCRIPTION OF THE DRAWINGS

FIG. 1 is a block diagram illustrating a configuration of an information processing apparatus according to a first embodiment;

FIG. 2 is a diagram illustrating a relation among a period, a mode, and data processing according to the first embodiment;

FIG. 3 is an explanatory diagram of data read/write methods in the information processing apparatus according to the first embodiment;

FIG. 4 is a diagram illustrating an example of an address map indicating memory address information in the information processing apparatus according to the first embodiment;

FIG. 5 is a diagram illustrating an example of an address map managed at the time of data restoration processing in the information processing apparatus according to the first embodiment;

FIG. 6 is a flowchart illustrating an example of a control method of the information processing apparatus according to the first embodiment; and

FIG. 7 is a diagram illustrating an example of an address map in an information processing apparatus according to a second embodiment.

### DETAILED DESCRIPTION

An information processing apparatus comprises a central processor, a volatile memory, a non-volatile memory, a backup line, and a controller. The volatile memory is configured in such a manner that data is input and output thereto and therefrom via a bus under control of the central processor. The non-volatile memory is configured in such a manner that data is input and output thereto and therefrom via the bus under control of the central processor. The backup line is provided between the volatile memory and the non-volatile memory. The controller is configured to control data transfer performed between the volatile memory and the non-volatile memory via the backup line in a transition period between a normal mode of supplying normal power to the volatile memory and a low power consumption mode of reducing or interrupting normal power to be supplied to the volatile memory.

The information processing apparatus and a control method of an information processing apparatus according to embodiments of the present invention will now be explained in detail with reference to the accompanying drawings. The embodiments described below are only examples of the embodiments of the present invention and the present invention is not to be construed as being limited to the embodiments. In the drawings referred in the embodiments, like parts or parts having identical functions are denoted by like or similar reference characters and there is a case where redundant explanations thereof are omitted. Further, for convenience of explanation, there are cases where dimensional ratios of the parts in the drawings are different from those of actual products and some part of configurations is omitted from the drawings.

### First Embodiment

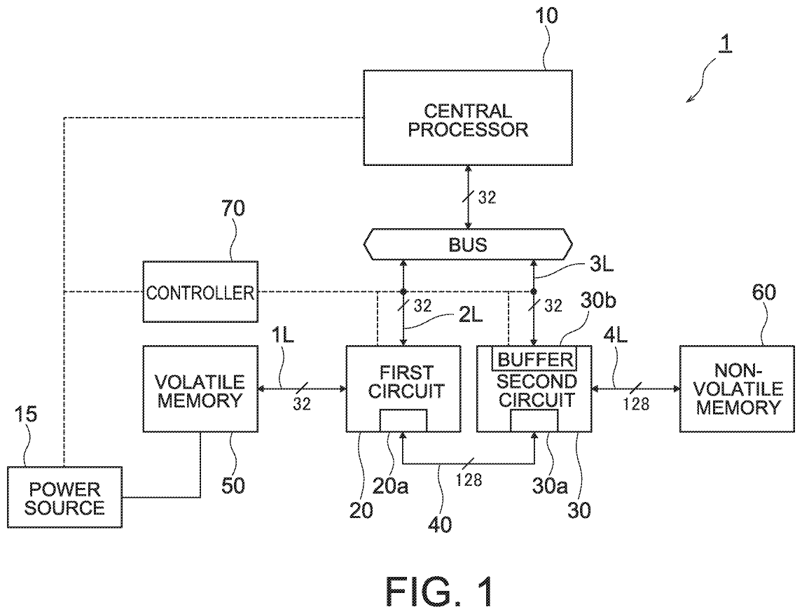

FIG. 1 is a block diagram illustrating a configuration of an information processing apparatus 1 according to a first embodiment. The information processing apparatus 1 includes a central processor 10, a power source 15, a first circuit 20, a second circuit 30, a backup line 40, a volatile memory 50, a non-volatile memory 60, and a controller 70. A bus BUS, a first line 1L, a second line 2L, a third line 3L, and a fourth line 4L are also illustrated in FIG. 1.

The central processor 10 is, for example, a CPU and controls processors in the information processing apparatus 1. In the normal use, the power source 15 is connected to the volatile memory 50 and the like via a power supply line and the volatile memory 50 becomes a state in which normal power is supplied thereto and data can be retained therein, under control of the central processor 10 (This state is referred to as “normal mode”. Details will be described later.). When a power interruption signal is then input to the central processor 10 by an operation of an operator, the power supplied from the power source 15 to the volatile memory 50 is reduced from the normal power or is interrupted and the volatile memory 50 transits to a state in which data cannot be retained therein (This state is referred to as “low power consumption mode”. Details will be described later.). When a return signal is thereafter input to the central processor 10 by an operation of the operator, the volatile memory 50 transits to the normal mode and power supplied from the power source 15 to the volatile memory 50 returns to the normal power.

The first circuit 20 is a circuit that converts a data line to perform data access to the volatile memory 50. The first circuit 20 is connected to the volatile memory 50 via the first line 1L and is connected to the bus BUS via the second line 2L. The bandwidths of the first line 1L and the second line 2L are the bus width and are, for example, 32 kilobits.

The first circuit 20 includes a first backup interface 20a. The backup line 40 is connected to the first backup interface 20a. Details of the first circuit 20 will be described later.

The second circuit 30 is a circuit that converts a data line to perform data access to the non-volatile memory 60. The second circuit 30 is connected to the bus BUS via the third line 3L and is connected to the non-volatile memory 60 via the fourth line 4L. The bandwidth of the third line 3L is the bus width and is, for example, 32 kilobits. Meanwhile, the bandwidth of the fourth line 4L is an integral multiple of the bus width and is, for example, 128 kilobits.

The second circuit 30 includes a second backup interface 30a and a buffer 30b. The backup line 40 is connected to the second backup interface 30a. The buffer 30b temporarily stores therein data that is input via the third line 3L. Because the access speed is low, the non-volatile memory 60 uses the fourth line 4L having a larger bandwidth than the bandwidth of the third line 3L, which is the bus width. Accordingly, the second circuit 30 performs a read/write operation of data temporarily stored in the buffer 30b from and to the non-volatile memory 60 with the bandwidth of the fourth line 4L.

The backup line 40 is a line for data transfer different from the bus BUS and is connected between the first backup interface 20a and the second backup interface 30a. The bandwidth of the backup line 40 is an integral multiple of that of the first line 1L, that is, an integral multiple of the bus width and is, for example, 128 kilobits.

The volatile memory 50 is, for example, an SRAM. While data can be read from and written into the volatile memory 50, written data is lost when the normal power is not supplied from the power source 15. That is, the volatile memory 50 cannot retain data in the low power consumption mode.

Data is read from and written into the volatile memory 50 via the first line 1L, the first circuit 20, the second line 2L, and the bus BUS under control of the central processor 10 in the normal period.

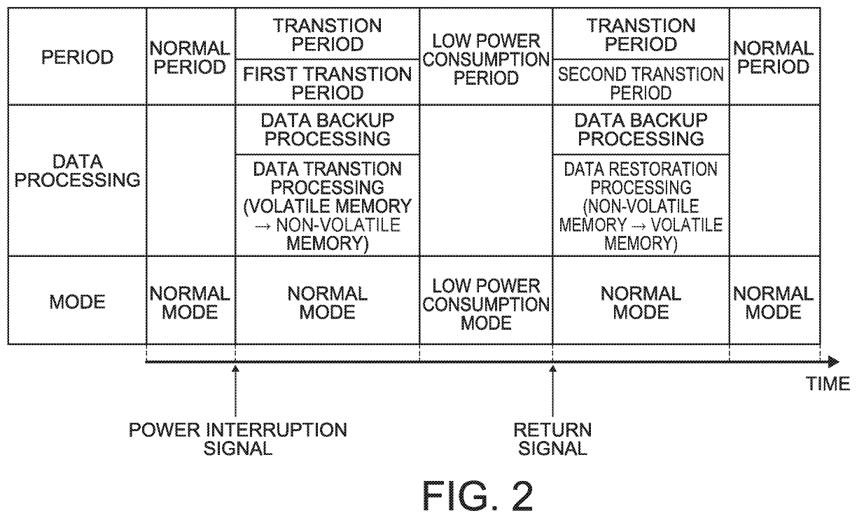

FIG. 2 is a diagram illustrating a relation among the period, the mode, and the data processing. “Modes”, “periods”, and the like are explained with reference to FIG. 2. A “normal mode” indicates a state in which the normal power is supplied from the power source 15 to the volatile memory 50 and the volatile memory 50 can retain data. Meanwhile, a “low power consumption mode” according to the present embodiment indicates a state in which the normal power supplied from the power source 15 to the volatile memory 50 is reduced or interrupted and the volatile memory 50 is disabled to retain data.

A period from a time when a power interruption signal is input until data transfer from the volatile memory 50 to the non-volatile memory 60 is completed to transit to the low power consumption mode is referred to as “first transition period”. A period from a time when a return signal is input until data transfer from the non-volatile memory 60 to the volatile memory 50 is completed is referred to as “second transition period”.

In the present embodiment, the first transition period and the second transition period are collectively referred to as “transition period”. That is, the transition period is a period corresponding to transition between the normal mode and the low power consumption mode. A period in the normal mode other than the transition period is referred to as “normal period”.

In the present embodiment, processing in the transition period is referred to as “data backup processing”. Further, data backup processing in the first transition period is referred to as “data transition processing”, and data backup processing in the second transition period is referred to as “data restoration processing”.

The non-volatile memory 60 is, for example, an eNVM (embedded Non-volatile Memory). Data can be read from and written into the non-volatile memory 60 and written data is retained therein even when power is not supplied from the power source 15. That is, the non-volatile memory 60 can retain data also in the low power consumption mode. Data is read from and written into the non-volatile memory 60 via the fourth line 4L, the second circuit 30, the third line 3L, and the bus BUS under control of the central processor 10 in the normal period.

The controller 70 is connected to the first circuit 20, the second circuit 30, and the central processor 10. The controller 70 is, for example, constituted of a processor. The term “processor” represents a circuit such as an ASIC (Application Specific Integrated Circuit), an SPLD (Simple Programmable Logic Device), and an FPGA (Field Programmable Gate Array).

The controller 70 controls data transfer between the volatile memory 50 and the non-volatile memory 60 via the backup line 40 in the transition period. Details of the controller 70 will be described later.

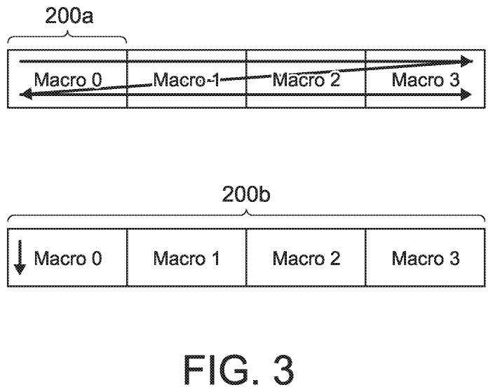

A detailed example of processing of the first circuit 20 is explained first with reference to FIG. 3. FIG. 3 is an explanatory diagram of data read/write methods of the first circuit 20 in the normal period and the transition period. The upper drawing illustrates a data read/write method in the normal period and the lower drawing illustrates a data read/write method in the transition period.

As illustrated in FIG. 3, the volatile memory 50 is constituted of a plurality of basic areas (Macro) 200a. Each of the basic areas 200a in the present embodiment corresponds to, for example, one memory address in the volatile memory 50. The data width of the basic area 200a is equal to the bus width. That is, the data width of the basic area 200a is the same as the bandwidth of the second line 2L and is, for example, 32 kilobits. In this way, the volatile memory 50 is constituted of the basic areas 200a each being an area corresponding to the bandwidth of the first line 1L.

In the normal period, the first circuit 20 accesses the volatile memory 50 via the bus BUS under control of the central processor 10 and accordingly reads data from the volatile memory 50 in such a manner that the basic areas 200a each corresponding to one memory address are switched by one memory address. On the other hand, in the transition period, the first circuit 20 accesses the volatile memory 50 via the backup line 40 under control of the controller 70 and accordingly reads data from the volatile memory 50 in such a manner that basic areas (Macro 0 to Macro 3) 200b each corresponding to four memory addresses are switched by one memory address. In this way, the first circuit 20 connects to the basic area 200a corresponding to one memory address at one time in the normal period, and connects to the basic area 200b corresponding to four memory addresses at one time in the transition period. Because this enables transfer of data complying with the wide bandwidth of the backup line 40 in the transition period, efficiency in the data transfer during data backup processing is improved.

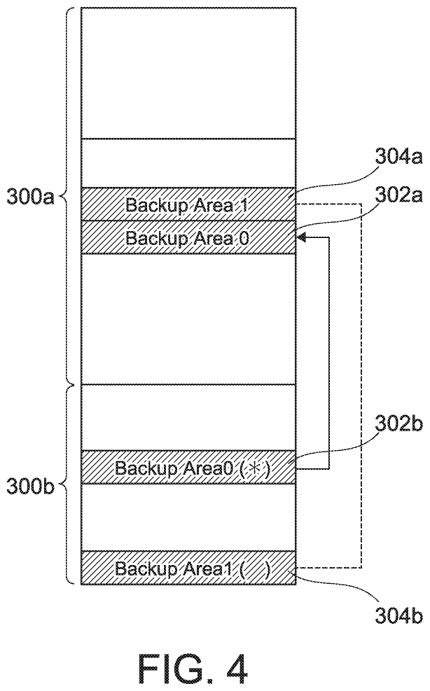

A detailed example of processing of the controller 70 is explained next. FIG. 4 is a diagram illustrating an example of an address map indicating memory address information managed by the controller 70. As illustrated in FIG. 4, the controller 70 defines a plurality of memory addresses (Backup Areas 0 and 1) 302a and 304a in a backup area 300a of the non-volatile memory 60. The controller 70 also defines a plurality of memory addresses (Backup Areas 0 and 1) 302b and 304b in a backup area 300b of the volatile memory 50 corresponding to the backup area 300a of the non-volatile memory 60. The address map is stored in, for example, the non-volatile memory 60. While the address map according to the present embodiment is stored in the non-volatile memory 60, the address map is not necessarily stored therein. For example, the address map may be stored in a non-volatile memory different from the non-volatile memory 60 managed by the controller 70.

An example of the data transition processing of transferring data from the volatile memory 50 to the non-volatile memory 60 is explained first with reference to FIG. 4. The controller 70 monitors information of data transferred through the second line 2L. Specifically, the controller 70 monitors whether data corresponding to memory addresses in the data backup area 300b is being transferred through the second line 2L during a time from when last data backup processing ends until next data backup processing starts. When the data is being transferred, the controller 70 assigns, for example, identification information to the corresponding memory address 302b as a storage area to which a rewrite operation has been performed. The memory address to which the identification information has been assigned is indicated by “*” in FIG. 4. In the next data transition processing, the controller 70 transfers only the data in the memory address 302b to which the identification information has been assigned, from the volatile memory 50 to a storage area at the corresponding memory address 302a in the non-volatile memory 60. Accordingly, it suffices to transfer to the non-volatile memory 60 data in a storage area into which the data has been newly written, and thus the data backup processing is speeded up. In this way, performing only necessary transfer enables the time of transition to the low power consumption mode to be shortened. The storage area according to the present embodiment corresponds to a rewrite area.

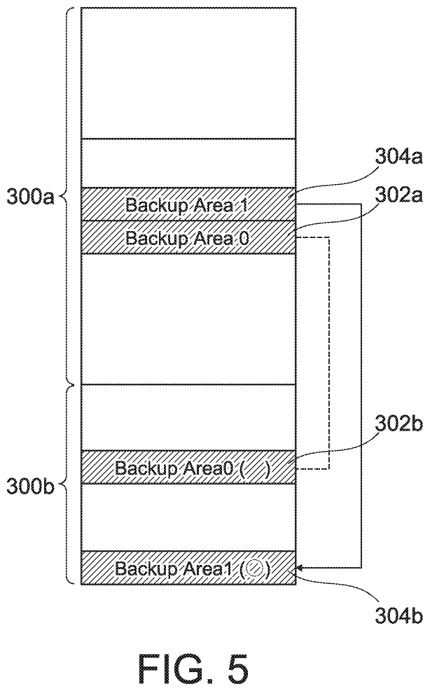

An example of the data restoration processing of transferring data from the non-volatile memory 60 to the volatile memory 50 is explained next with reference to FIG. 5. FIG. 5 is a diagram illustrating an example of an address map indicating memory address information managed by the controller 70 at the time of data restoration processing.

The controller 70 assigns, for example, identification information to the memory address 304b corresponding to data transferred from the backup area 300a of the non-volatile memory 60 to the backup area 300b of the volatile memory 50. The identification information is indicated by “o” in FIG. 5.

Accordingly, when the central processor 10 attempts to read data in a storage area corresponding to the memory address 302b where transfer of data has not been completed in the backup area 300b, the controller 70 enables the read operation to be kept on standby (stalled). On the other hand, when the central processor 10 attempts to read data in a storage area corresponding to the memory address 304b where transfer of data has been completed in the backup area 300b, the controller 70 permits the read operation. Accordingly, the central processor 10 can access transferred data of the volatile memory 50 even during data restoration processing, and the system performance of the information processing apparatus 1 is improved.

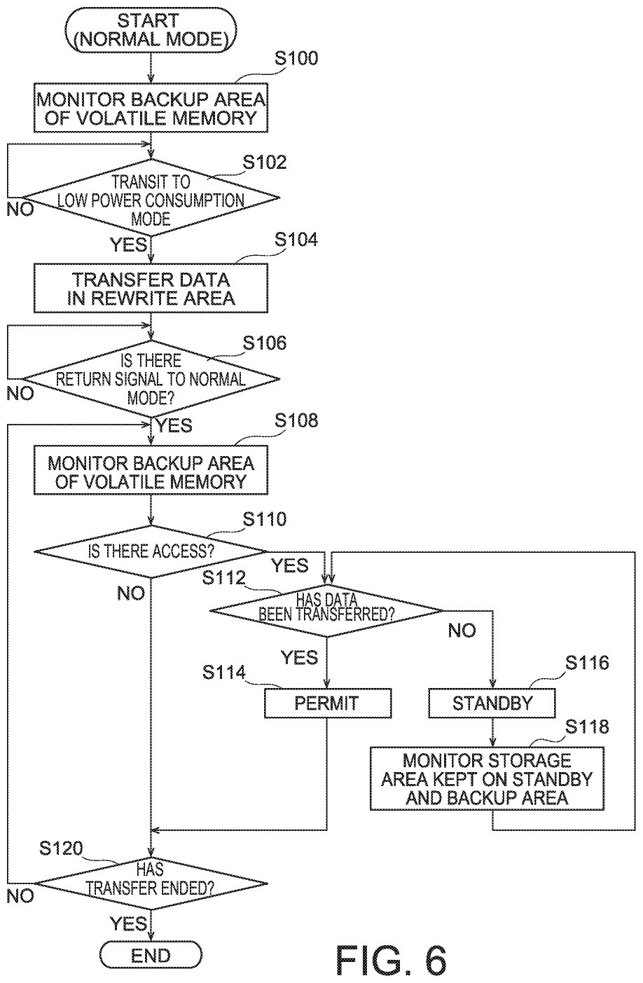

FIG. 6 is a flowchart illustrating an example of a control method of the information processing apparatus 1. An example of control executed from when previous data backup processing ends until current data backup processing ends is explained below.

First, the controller 70 monitors whether data corresponding to a memory address in the backup area 300b of the volatile memory 50 is being transferred through the second line 2L (Step S100). When data is newly written into a storage area corresponding to a memory address in the back area 300b, the controller 70 assigns identification information (*) to the corresponding memory address in the address map.

Next, the controller 70 monitors the power interruption signal to the central processor 10 to determine whether transition to the low power consumption mode is started (Step S102). That is, when the power interruption signal is not received yet, the controller 70 determines that transition to the low power consumption mode is not started (NO at Step S102) and repeats processing at Step S102 to continue to monitor the power interruption signal until the power interruption signal is received.

On the other hand, when the power interruption signal is input and it is determined that transition to the low power consumption mode is started (YES at Step 102), the controller 70 transfers data corresponding to the memory address to which the identification information has been assigned in the address map from the volatile memory 50 to the non-volatile memory 60 (Step S104). When the transfer ends, the controller 70 outputs an end signal to the central processor 10. Accordingly, the central processor 10 transits to the low power consumption mode.

Next, the controller 70 monitors the return signal to the central processor 10 to determine whether transition to the normal mode is started (Step S106). That is, when the return signal is not received yet, the controller 70 determines that transition to the normal mode is not started (NO at Step S106) and repeats processing at Step S106 to continue to monitor the return signal until the return signal is received.

On the other hand, when the return signal is input and it is determined that transition to the normal mode has been performed (YES at Step S106), the controller 70 monitors a status of data transfer to the backup area 300b of the volatile memory 50 (Step S108). The controller 70 then assigns identification information (o) to a memory address corresponding to the data transferred area in the backup area 300b.

Subsequently, the controller 70 determines whether there is any access from the central processor 10 to a storage area in the backup area 300b of the volatile memory 50 (Step S110). When it is determined that there is access (YES at Step S110), the controller 70 determines whether data has been transferred (Step S112). When determining that data has been transferred (YES at Step S112), the controller 70 permits the central processor 10 to access the storage area (Step S114).

On the other hand, when determining that data has not been transferred yet (NO at Step S112), the controller 70 keeps on standby the access of the central processor 10 to the storage area (Step S116). Subsequently, the controller 70 continuously monitors the storage area to which the access is kept on standby and the backup area 300b (Step S118) and repeats processing from Step S112.

Next, the controller 70 determines whether data transfer from the backup area 300a of the non-volatile memory 60 to the backup area 300b of the volatile memory 50 has ended (Step S120). When determining that the data transfer has not ended yet (NO at Step S120), the controller 70 repeats processing from Step S108. On the other hand, when determining that the data transfer has ended (YES at Step S120), the controller 70 ends the data backup processing of this time.

In this way, the controller 70 transfers updated data in the backup area 300b of the volatile memory 50 to the non-volatile memory 60 at the time of data transition processing. Meanwhile, at the time of return processing, the controller 70 monitors data transfer from the backup area 300a of the non-volatile memory 60 to the volatile memory 50. The controller 70 permits the central processor 10 to access a storage area when data has been already transferred, and keeps the access on standby when the data has not been transferred yet.

As explained above, according to the present embodiment, the backup line 40 that connects the volatile memory 50 and the non-volatile memory 60 to each other is provided, and the controller 70 controls data transfer between the volatile memory 50 and the non-volatile memory 60 via the backup line 40 in a transition period between the normal mode and the low power consumption mode. Accordingly, data transfer between the volatile memory 50 and the non-volatile memory 60 can be performed by a control system independent of the central processor 10 and the bus BUS, whereby a high transfer rate can be provided during data backup processing. Therefore, the data transfer time at the time of mode transition can be shortened.

### Second Embodiment

The information processing apparatus 1 according to a second embodiment is different from the information processing apparatus 1 according to the first embodiment in that it can set priorities to storage areas in the backup area 300b of the volatile memory 50 and transfers data from the non-volatile memory 60 to the volatile memory 50 according to the priorities. The differences between the information processing apparatus 1 according to the second embodiment and the information processing apparatus 1 according to the first embodiment are described below.

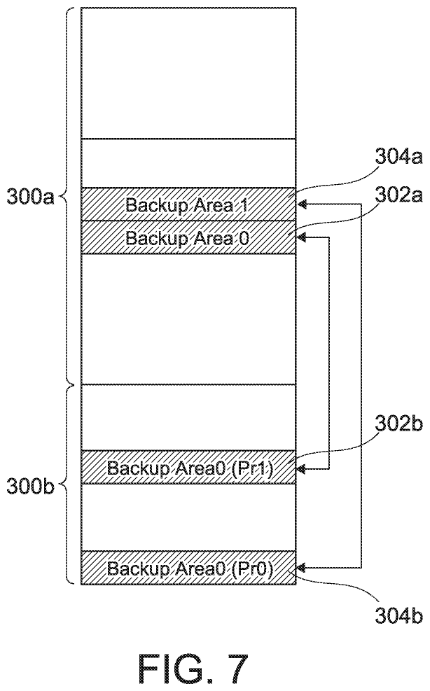

FIG. 7 is a diagram illustrating an example of an address map indicating memory address information that is managed by the controller 70 according to the second embodiment at the time of data restoration processing. As illustrated in FIG. 7, priorities (Pr0 and Pr1) are assigned to the memory addresses (Backup Areas 0 and 1) 302b and 304b in the backup area 300b of the volatile memory 50. It is assumed in this example that Pr0 is higher than Pr1 in the priority. More specifically, a higher priority is set to a memory address as the likelihood that the central processor 10 accesses the memory address at the time of data restoration processing is higher. For example, the controller 70 monitors the access status of the central processor 10 at the time of last data restoration processing and sets access priorities in the order of access by the central processor 10.

As described above, according to the second embodiment, data is transferred from the non-volatile memory 60 to the volatile memory 50 according to the priorities at the time of data restoration processing. Therefore, data can be transferred in descending order of the likelihood of access by the central processor 10 and the frequency that the central processor 10 is kept on standby can be reduced.

According to at least one of the embodiments described above in detail, data transfer between the volatile memory 50 and the non-volatile memory 60 can be performed via the backup line 40, and thus a high transfer rate can be maintained at the time of data backup processing. Therefore, the data transfer time during mode transition can be shortened.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus comprising:
a central processor;
a volatile memory configured in such a manner that data is input and output thereto and therefrom via a bus under control of the central processor;
a non-volatile memory configured in such a manner that data is input and output thereto and therefrom via the bus under control of the central processor;
a backup line provided between the volatile memory and the non-volatile memory; and
a controller configured to control data transfer performed between the volatile memory and the non-volatile memory via the backup line in a transition period between a normal mode of supplying normal power to the volatile memory and a low power consumption mode of reducing or interrupting normal power to be supplied to the volatile memory.

2. The apparatus of claim 1, wherein the controller manages a rewrite area into which data among data in a backup area of the volatile memory has been rewritten in a period from when the transition period is ended until when a subsequent one of the transition period is started, and transfers rewritten data in the rewrite area to the non-volatile memory via the backup line at a time of subsequent transition from the normal mode to the low power consumption mode.

3. The apparatus of claim 1, wherein
the controller
manages a rewrite area of data having been transferred from the non-volatile memory to a backup area of the volatile memory via the backup line,
keeps a read operation on standby when the central processor attempts to read data in the rewrite area, where transfer of the data not having been completed in the backup area, and
permits a read operation when the central processor attempts to read data in the rewrite area, where transfer of the data having been completed in the backup area.

4. The apparatus of claim 1, wherein the controller is capable of setting priorities to storage areas in a backup area of the volatile memory, and transfers data from the non-volatile memory to the volatile memory in order of the priorities.

5. The apparatus of claim 1, further comprising:
a first circuit connected to the volatile memory and configured to convert a data line to perform data access to the volatile memory; and
a second circuit connected to the non-volatile memory and configured to convert a data line to perform data access to the non-volatile memory, wherein
the backup line is connected between the first circuit and the second circuit, and
data transfer between the volatile memory and the non-volatile memory is performed via the first circuit, the backup line, and the second circuit.

6. The apparatus of claim 5, wherein the first circuit uses different data read/write methods according to a first case of transferring data to the volatile memory via the bus or a second case of transferring data to the volatile memory via the backup line.

7. The apparatus of claim 6, wherein
the backup line has a bandwidth being an integral multiple of a bandwidth of a first line connecting the first circuit and the volatile memory to each other,
a rewrite area of the volatile memory includes an area corresponding to the bandwidth of the first line as a basic area, and
the first circuit connects to data in the basic area in the first case, and connects to data of the integral multiple of the basic area in the second case.

8. A control method of an information processing apparatus comprising a central processor configured to control parts of the apparatus, a volatile memory configured to store therein data via a bus under control of the central processor, a non-volatile memory configured to store therein data via the bus under control of the central processor, and a backup line different from the bus connecting the volatile memory and the non-volatile memory to each other, the method comprising:
performing data transfer between the volatile memory and the non-volatile memory via the backup line in a transition period between a normal mode of supplying normal power to the volatile memory and a low power consumption mode of reducing or interrupting the normal power to be supplied to the volatile memory.

9. The method of claim 8, further comprising:
managing a rewrite area into which data among data in a backup area of the volatile memory has been rewritten in a period from when the transition period is ended until when a subsequent one of the transition period is started; and
transferring rewritten data in the rewrite area to the non-volatile memory via the backup line at a time of subsequent transition from the normal mode to the low power consumption mode.

10. The method of claim 8, further comprising:
managing a rewrite area of data having been transferred from the non-volatile memory to a backup area of the volatile memory via the backup line;
keeping a read operation on standby when the central processor attempts to read data in the rewrite area, where transfer of the data not having been completed in the backup area; and
permitting a read operation when the central processor attempts to read data in the rewrite area, where transfer of the data having been completed in the backup area.

11. The method of claim 8, wherein
it is possible to set priorities to storage areas in a backup area of the volatile memory, and
the method further comprising transferring data from the non-volatile memory to the volatile memory in order of the priorities.

12. The method of claim 8, wherein
the backup line is connected between a first circuit connected to the volatile memory and configured to convert a data line to perform data access to the volatile memory and a second circuit connected to the non-volatile memory and configured to convert a data line to perform data access to the non-volatile memory, and
data transfer between the volatile memory and the non-volatile memory is performed via the first circuit, the backup line, and the second circuit.

13. The method of claim 12, comprising using, by the first circuit, different data read/write methods between a first case of transferring data to the volatile memory via the bus and a second case of transferring data to the volatile memory via the backup line.

14. The method of claim 13, wherein
the backup line has a bandwidth being an integral multiple of a bandwidth of a first line connecting the first circuit and the volatile memory to each other,
a rewrite area of the volatile memory includes an area corresponding to the bandwidth of the first line as a basic area, and
the first circuit has a process of connecting to data in the basic area in the first case, and a process of connecting to data of the integral multiple of the basic area in the second case.
